(19) United States
(12) Patent Application Publication
(10) Pub. No.: US 2022/0057914 A1
(43) Pub. Date: Feb. 24, 2022

(54) AUGMENTED REALITY TARGETING SYSTEM

(71) Applicant: Jason Sauers, Denver, CO (US)

(72) Inventor: Jason Sauers, Denver, CO (US)

(21) Appl. No.: 17/404,596

(22) Filed: Aug. 17, 2021

Related U.S. Application Data
(60) Provisional application No. 63/067,734, filed on Aug. 19, 2020.

(51) Int. Cl. G06F 3/0481; G06T 19/00; G06F 3/0484; G06F 3/0346; G06Q 30/02; A63F 13/52

(52) U.S. Cl. CPC G06F 3/04815; G06T 19/006; G06F 3/04842; G06T 2200/24; G06Q 30/0241; A63F 13/52; G06F 3/0346

(57) ABSTRACT

The illustrated augmented reality system (400) includes user devices (402), a system platform (404), advertiser platforms (406), and third-party databases (408). The user devices (402) overlay virtual application objects on the display (410) of real-world digital images from a camera (438). The user can then manipulate the user device (402) to target application objects of interest. Upon targeting of an application object, an account of the user can be credited, for example, with a coupon value or discount value. Such value can be realized upon a conversion event such as a website visit or product purchase. The third-party databases (408) can be used to target application objects to desired users and to analyze the effectiveness of a campaign.

### CROSS-REFERENCE TO RELATED APPLICATION

This application claims the benefit of U.S. Provisional Patent Application No. 63/067,734, entitled, “AUGMENTED REALITY TARGETING SYSTEM,” filed on Aug. 19, 2020. The contents of the above-noted application is incorporated herein as if set forth in full and priority to this application is claimed to the full extent allowable under U.S. law and regulations.

### FIELD OF THE INVENTION

The present invention relates generally to virtual environment systems and, in particular, to a system for enabling a user to interact with virtual objects, superimposed or overlaid on real-world digital images, based on spatial sensors of an input device. The invention is applicable in a variety of application environments including gaming and advertising.

### BACKGROUND OF THE INVENTION

In recent decades, virtual environment systems including virtual reality systems and augmented reality systems have been developed for a variety of applications. In a typical virtual reality system, a user is fully immersed in a virtual environment, for example, rendered via a virtual reality headset. The user may be able to navigate in and interact with the virtual environment by moving his or her head or using a connected input device. Movements of the headset may be sensed by integrated sensors and then processed to generate a corresponding change of perspective with respect to the virtual environment. Such virtual reality devices are employed in a variety of applications where complete immersion in the virtual environment is desirable, including certain gaming and training simulation applications.

In augmented reality systems, virtual objects are overlaid on a real-world digital image for a variety of purposes. For example, a virtual background image may be shown behind a user during videoconferencing, a navigation system may overlay a desired route on a digital image, or information may be overlaid on a patient image during surgery to assist a surgeon. A well-known application of augmented reality is Pokémon GO™ where virtual characters are overlaid on augmented real-world images. Such augmented reality systems may use sensor information and image information from the user device running the application. The augmented reality application may use markers or other image information to assist in positioning a virtual object in relation to the real-world image. It will be appreciated that this may require substantial processing and, even so, is limited in relation to user interaction with the virtual objects.

### SUMMARY OF THE INVENTION

The present invention is directed to a system and associated functionality for overlaying virtual objects on a real-world image and enabling targeting of the virtual objects using sensors of a user device such as a phone or tablet computer. The virtual objects may be rendered in relation to a virtual space correlated to the real-world image. In this manner, the virtual objects can be readily rendered and may move in a defined way relative to the virtual space as well as the digital image space. The virtual objects can be targeted in relation to a field of view of the digital image to enable user interaction with the virtual objects. This facilitates a variety of application functionality relating to, for example, gaming and advertising.

In accordance with one aspect of the present invention, a system and associated functionality are provided for allowing user devices to interact with a virtual application space. This involves establishing an application space including a virtual spatial environment defined by spatial axes. One or more application objects may be rendered in relation to the application space. A user device having device sensors indicating a real-world position and orientation provide sensor information. The sensor information can then be used to establish a dynamically variable field of view for a display of the user device relative to the application space. The field of view can then be modified to identify a targeting of a first application object within the field of view so as to enable interaction of the user with the application object.

In certain applications, the virtual application environment may be defined in relation to three spatial axes. The rendering of the first application object may involve depicting the application object as an image element on the display of the user device at a display location correlated to a position in the application space. The first application object may have a time-dependent position relative to the application space. For example, movement of the virtual object in relation to the virtual space may be in accordance with a defined velocity and/or acceleration profile over time.

In certain embodiments, the user device may include a camera and a processor. The camera is operative for providing real-time digital images of a real-world environment on the display. The processor is operative to overlay the application objects of the application space on the real-time digital images of the real-world environment. In this regard, the noted field of view may correspond to a field of view of the camera. The field of view may be defined in relation to the application space using the sensor information including, for example, position sensor information and orientation information. To assist in targeting of application objects, one or more targeting aids, such as reticles, may be rendered relative to the application space on the display. The user can employ the targeting aids to target and select an application object. Upon successful targeting of the object, a display of the application object may be altered to confirm selection. For example, one or more of a size, orientation, and framing of the application object may provide confirmation to the user of a desired interaction. Thus, interaction may be implemented with or without any user input separate from manipulating the user device to achieve targeting.

In accordance with another aspect of the present invention, a promotional system and associated functionality are provided. The system includes a user device for generating application objects relating to third-party products or services. Individual ones of the application objects may be associated with application values. An application space including the application objects is superimposed on a digital image space. The user device may then obtain user targeting information to identify targeting of a first application object and render a targeting effect relating to the targeting of the object. In conjunction with such targeting, user selection information may be obtained relating to selection of the first application object by the user. A first application value corresponding to the first object can then be credited in response to the selection. Finally, the application value may be reported to a network platform. For example, the first application object may be an advertising or promotional object of a first advertiser or provider of goods or services. The credited value may then be made available for redemption in connection with a transaction between the user and the first provider.

In accordance with a still further aspect of the present invention, an associated network platform and associated functionality may be provided. The functionality involves receiving application information from the user device related to selection of a first application object by a first user. The network platform can then access storage to credit a first value to an account of the first user in relation to the selection of the application object, where the first value is redeemable in connection with a transaction between the first user and a first provider of goods and services. Account information may then be provided, from the platform to the first provider, concerning the account of the first user. For example, the first value may relate to a discount, service enhancement, or other incentive related to the transaction. Information may also be provided to other applications to monitor and measure the effectiveness of a promotion implemented in relation to the virtual application objects.

### BRIEF DESCRIPTION OF THE DRAWINGS

FIG. 1 is a schematic diagram illustrating an augmented reality system in accordance with the present invention;

FIG. 2 is a schematic diagram illustrating a process for manipulating a user device to target an application object in accordance with the present invention;

FIGS. 3-4 are block diagrams illustrating an augmented reality system in accordance with the present invention;

FIG. 5 is a flowchart illustrating a process for operating an augmented reality system in accordance with the present invention; and

FIG. 6 is a flowchart illustrating a process for operating a promotional system in accordance with the present invention.

### DETAILED DESCRIPTION

In the following description, the invention is set forth in the context of certain use cases related to advertising and gaming. These use cases are effective to illustrate the operation and advantages of the present invention. However, it will be understood that the invention is not limited to such use cases or contexts but is more generally applicable across a range of applications.

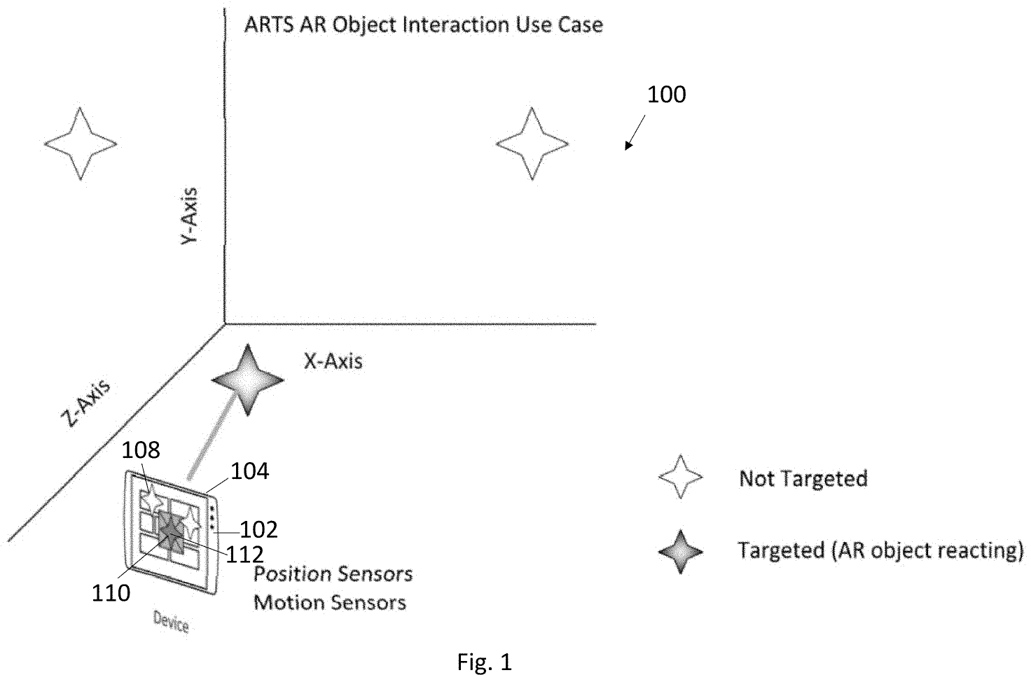

FIG. 1 illustrates an augmented reality system 100 in accordance with the present invention. The system 100 includes a user device 102 having a display 104. As will be described in more detail below, the illustrated user device 102 also includes position and orientation sensors, a Global Positioning System (GPS) module or similar positioning system module, and a processor for running an Augmented Reality (AR) application, as well as data network communications functionality. For example, the user device 102 may be embodied in a phone or tablet computer. In the illustrated example, a camera of the user device 102 is operated to display real time digital video images, including real image elements 106, of a real-world environment on the display 104. The user device 102 also displays virtual application objects 108 on the display 104.

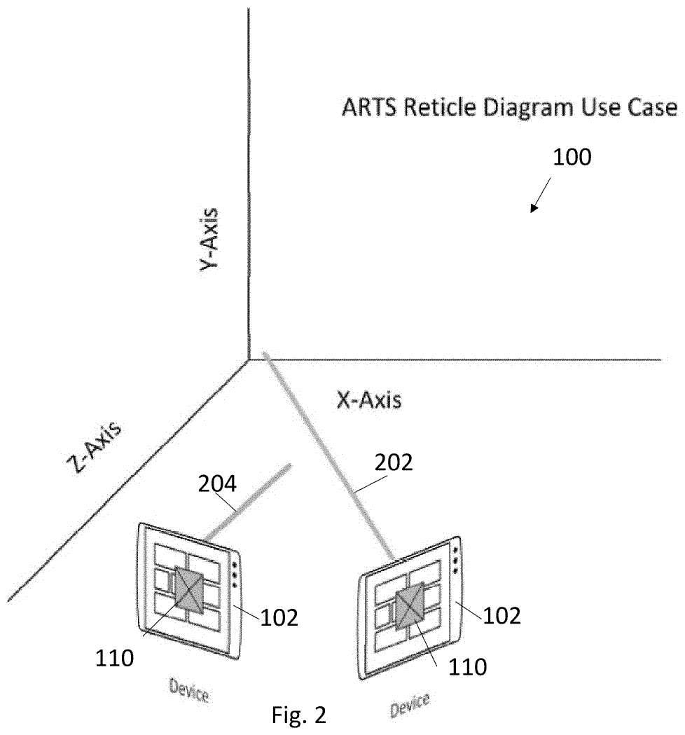

The position and movement of the application objects is defined in relation to a virtual application space. As shown in FIGS. 1-2, the application space is defined in relation to three dimensional spatial coordinates. Thus, each of the application objects 108 can have a position, velocity, acceleration, angular orientation, angular velocity, and angular acceleration that can be defined on a time-dependent basis in relation to the noted axes. All of this position and orientation related information can be correlated to a real-world three-dimensional space as depicted in the display 104. That is, the real-world image is defined by the position and orientation of the camera as well as the imaging optics of the camera, and the application objects are defined by the calculated position and orientation of the camera and a defined virtual field of view of the camera in relation to the application space. Such correlation may or may not have a defined scale or rigid spatial consistency over time, but can nonetheless convey a perspective and vantage, as well as variations thereof, that support the illusion that the application objects are present in the real-world image. Thus, for example, a field of view of the camera of the user device 102 may be correlated to a corresponding region of the application space and that region may be translated and rotated in relation to the application space based on information from the device sensors as described in more detail below.

Consequently, as shown in FIG. 1, application objects 108 that are within the field of view as projected onto the application space at a given moment in time will be digitally overlaid on the display 104. Moreover, a targeting aid such as a reticle 110 are digitally overlaid on the display 104. In this manner, a targeted application object 112 may be targeted by manipulating the user device 102 so that the targeted object 112 is centered within the reticle 110. In one implementation, targeting causes an effect on the object 112. For example, targeting may cause the object 112 to assume an upright orientation, to become enlarged or move into the foreground, to change colors, or to otherwise be highlighted. The user can then interact with that singular object 112. A user may interact with or select the targeted object 112 simply by centering the targeted object 112 in the reticle 110 or another user input, such as tapping the screen, may be utilized to select the targeted object 112. For example, such selection may result in a visual, audible and/or tactile indication to the user that selection has occurred, e.g., that an application value has been awarded such as game points or marketing incentives.

FIG. 2 illustrates the process of manipulating the user device 102 to target an application object. In particular, movement of the device 102 may involve translation of the device position relative to the illustrated axes and rotation of the orientation of the user device 102 relative to one or more of the axes. Such movement may be detected by position and orientation sensors of the user device 102 which may include accelerometers, a compass, and tilt sensors. For example, outputs from the sensors may be integrated over a movement event to calculate and recalculate the position of the device 102 in relation to the application space. Moreover, targeting axes 202 and 204 may be calculated in relation to the current position and orientation of the device 102 and a reticle 110 may be displayed using the same information. An application object may be deemed to be targeted when the current position of the application object in relation to the application space intersects or falls within a determined proximity of the targeting axis 202 or 204. In one implementation, upon successful targeting, the targeted application object assumes an upright orientation, is depicted as drawing into the foreground of the digital image such that its size increases, and the framing of the application object associated with the reticle 110 can change colors to draw attention to the targeted application object. Optionally, other effects such as sounds may be generated.

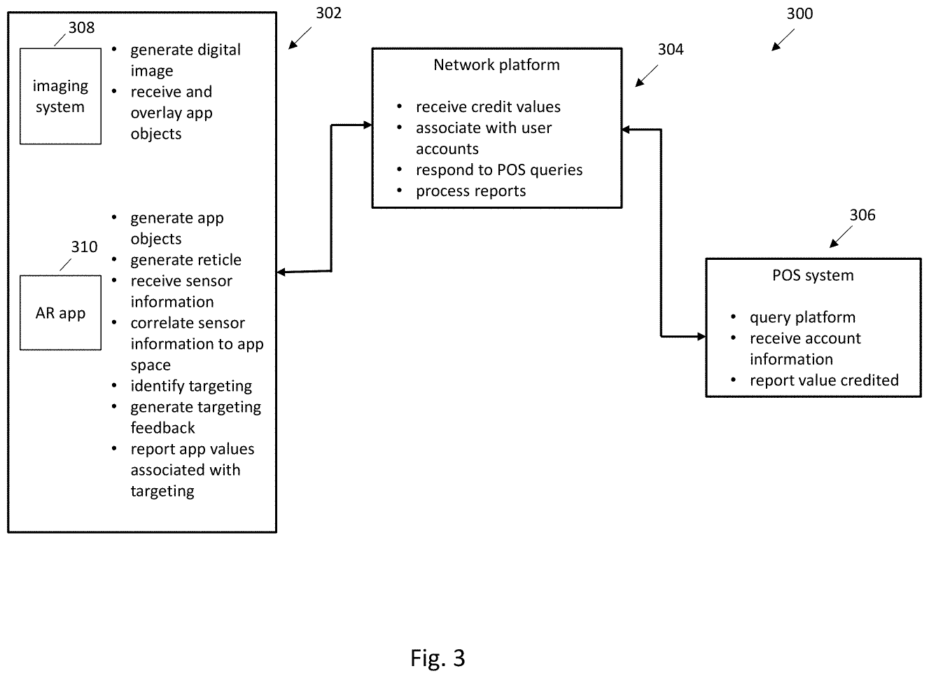

The augmented reality system of the present invention can be implemented in connection with a variety of applications and use cases. FIG. 3 illustrates a use case associated with a marketing or advertising system 300. In such a case, the application objects may be logos, still frame or video advertisements, icons, or depictions of products of interest by way of example. Such objects may be displayed independently of the geographical location and orientation of the user device. Alternatively, the application objects displayed may depend on a geographical location of the device or information within the field of view of the device. For example, specific promotional application objects may be selected for display when the user device is located in a mall or airport, or specific promotional application objects may be selected when a QR code, billboard, television or streaming advertising/content, or other defined element is detected within the camera image.

The illustrated system 300 includes a number of user devices 302, one or more network platforms 304, and a number of point-of-sale systems 306. Each user device 302 includes an imaging system 308 and a processor running an AR application 310. Although the imaging system 308 and AR application 310 are illustrated as residing on the same device, they may be distributed across separate devices. The imaging system 308 is operative to generate a digital image and receive and digitally overlay application objects generated by the AR application 310. The AR application is operative to generate the application objects and reticles. In addition, the AR application 310 receives sensor information relating to the position and orientation of the user device 302 and correlates the sensor information to the application space so that appropriate instructions may be provided to the imaging system 308 for overlaying the application objects. The AR application 310 also identifies successful targeting of an application object and generates targeting feedback as described above. Finally, the AR application 310 is operative to report application values associated with such targeting. In the case of a promotional or advertising application, for example, the targeting values may be credit awarded to the user for targeting the application object of an advertiser. Such credits may be redeemable as price discounts, service enhancements, or other incentives.

The network platform 304 receives the credit values and associates the credit values with user accounts. Thus, for example, a report from the user device 302 may include an identification of the user, an application value, and an associated provider of goods or services, e.g., the advertiser. The network platform 304 can use this information to apply appropriate credits to an account of the identified user. The network platform 304 is further operative to responding to queries from a point of service system 306 as described below and process such reports to update user accounts.

The point-of-sale systems 306 may be associated with online or retail outlets or other locations associated with consummating or processing transactions. In one example, a point-of-sale system may be associated with a retail outlet such as a grocery store. The point-of-sale system 306 may query the network platform 304 at the time of a transaction or periodically to obtain information concerning credit values of customers. Then, when products are presented for purchase, the POS system 306 may identify products that participate in a promotional campaign associated with the network platform 304, retrieve credit information of the customer for the product under consideration, and apply or offer to apply the credit in relation to the transaction. If a credit value is redeemed, the point-of-sale system 306 may report the redemption to the network platform 304.

Although not illustrated, the credit values and/or the redemption thereof may be reported to an application for analyzing advertising effectiveness. For example, such an application may calculate various parameters relating to conversion rates associated with advertising via the system 300.

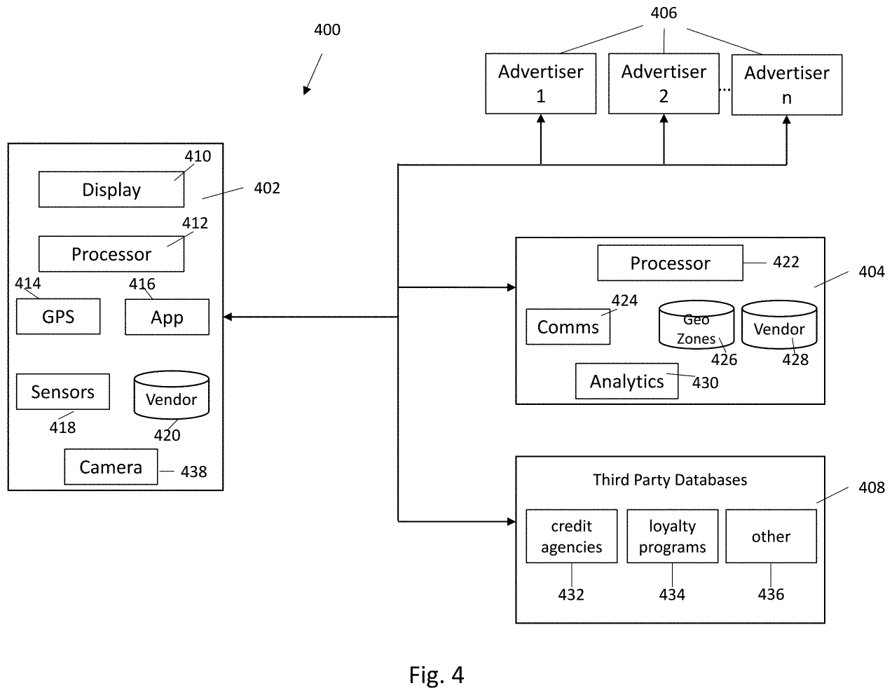

FIG. 4 is a block diagram illustrating an augmented reality promotional system 400 in accordance with the present invention. The illustrated system 400 includes a number of user devices 402 (only one shown), a system platform 404, a number of advertiser platforms 406, and a number of third-party databases 408. Each of these elements is described in more detail below.

The user devices 402 are employed by users to access and use various functionality of the system 400. For example, the user devices 402 may be embodied in a mobile telephone, tablet computer, or other data device of the user. The illustrated device 402 includes a camera 438 such as a video camera. For example, the camera 438 may be a video camera provided as part of the user device 402. The illustrated device 402 further includes a GPS module 414 and an augmented reality application 416 that may, for example, run on the processor 412. As discussed above, the location of the device 402 may be used by the application 416. In this regard, geo-coordinates of the device 402 may be provided by the GPS module 414. Alternatively, location information for the module 402 may be provided by another location system such as an alternative satellite-based location system, a location system of a mobile telephone network (e.g., providing coordinates based on angle of arrival, time difference of arrival, cell, cell sector, microcell, or other location technologies), or another source of location information. It will be appreciated that the location information may be obtained at the user device 402 and/or via a location gateway or other network platform.

The application 416 executes various functionality of the augmented reality system as disclosed herein. For example, the application 416 can determine the position and orientation of the camera 438, derive spatial information concerning a field of view of the camera 438, communicate with the platform 404, obtain vendor information concerning promotional campaigns, and the like. The illustrated device 402 further includes sensors 418 such as accelerometers, tilt sensors, and the like to provide position information for the device 402 and derivatives thereof such as position, velocity, acceleration, angular position, angular velocity, angular acceleration, attitude, and the like. It will be appreciated that position information from the GPS module 414, information from the sensors 418, and information related to the camera 438 such as field of view, zoom settings, and the like can be used to derive spatial information concerning the field of view of the camera 438.

The user device 402 may also store vendor information 420. For example, such vendor information 420 may relate to geographic zones of an advertising campaign, promotional terms and values, campaign parameters such as time of day or day of the week when the campaign is active, and the like. It will be appreciated that such vendor information may be stored on the device 402, stored on the platform 404, distributed between the device 402 and the platform 404, stored on both the device 402 and platform 404, or stored elsewhere for access by the device 402 and/or platform 404. The illustrated device 402 further includes a processor 412 for controlling operation of the application 416 and other elements and a display 410 for displaying image information from the camera 438 with overlaid application objects among other things.

The platform 404 communicates with the user devices 402 as well as the advertiser platforms 406 and third-party databases 408 to execute various functionality of the system 400. In this regard, the platform 404 includes a communications module 424 for communicating with the devices 402, platforms 406, and databases 408. For example, the platform 404 may be a cloud-based platform embodied in one or more machines such as servers disposed at a single location or geographically distributed. The platform 404 may communicate with the devices 402, platforms 406, and databases 408 via a local area network or wide area network such as the Internet.

The illustrated platform 44 includes geo zone information 426 and vendor information 428. The geo zone information 426 defines various geographical zones that may be used in advertising campaigns. The zones may be predefined advertising zones that can be selected by advertisers or custom advertising zones defined by advertisers. For example, predefined zones may be defined in relation to cities, neighborhoods, ZIP Codes, specific locations such as malls, airports, train stations, or boundaries for events such as concerts, fairs, and the like. Custom zones may relate to franchise boundaries, delivery areas, service areas or other geographies of interest individual advertisers. It will be appreciated that many other examples of zones may be provided such as political boundaries, network boundaries, and other geographies of interest. As described above, vendor information may relate to geographical zones of an advertising campaign, advertising content, campaign parameters such as time of day and day of the week, and other information defining an advertising campaign of a vendor.

The illustrated platform 404 also includes an analytics module 430. The analytics module 430 can perform a variety of analyses related to advertising campaigns such as analyzing advertising effectiveness and reach. In this regard the module 430 may track advertising objects that were presented or displayed to users, advertising objects that were targeted by users, demographic information regarding users, information concerning website visits, product purchases, or other conversions made by users, and the like. This information can be used, for example, to provide reports to advertisers concerning the effectiveness of various campaigns.

The advertiser platforms 406 can access the platform 404 to initiate orders, enter campaign information, upload advertising content, and monitor campaign progress among other things. In this regard, the platform 404 may provide a number of user interfaces to assist the advertisers in entering campaign information. For example, user interface screens may be provided that facilitate the process of defining geographical zones for the campaign, defining the time of day and days of the week for a campaign, defining the duration of the campaign, defining a target number of impressions, defining demographic parameters of the target audience, and entering any other desired attributes and constraints for the campaign. Once the campaign has been initiated, an advertiser may log in to the platform 404 to view progress of the campaign towards campaign goals, e.g., in terms of total impressions, conversions, costs, or the like. During the campaign or at the conclusion of one or more campaigns, the platform 404 may generate reports and billing statements that can be accessed by the advertisers 406. Those reports may include, for example, the total number of advertising opportunities (presentations or displays of advertising objects), total number of advertising objects targeted by users, demographic information concerning advertising opportunities and objects targeted, information concerning conversions, and any other information of interest to advertisers.

The platform 404 may also access third-party databases 408 to obtain information for targeting advertising objects and obtaining information for analyzing campaigns. It will be appreciated that advertisers may specify targeting parameters for a targeted audience of an advertising campaign. For example, providers of pet products may target pet owners, car manufacturers may target automobile intenders, and various consumer products may target specific audience segments defined by demographic parameters. Moreover, a given advertiser may have different audience segments that are targeted in different locations. For example, Ford Motor Company may target one audience segment of interest at auto shows and another audience segment of interest in baby product retail outlets. Moreover, different campaigns of different advertisers may be provided to different audience segments at the same location or geographic zone. For example, within a mall, some consumers may be presented with advertising opportunities for beer or pet products whereas other consumers may be presented with advertising opportunities for investment services or luxury automobile brands. Moreover, demographic information, purchasing behavior, and other information may be useful in connection with executing analytics concerning advertising campaigns.

The third-party databases 408 may be accessed for at least these purposes. In the illustrated example, the third-party databases 408 include credit agencies 432 such as Experian, loyalty program databases 434 such as loyalty programs associated with supermarkets or other stores, and other databases 436 such as databases that include information regarding subscriptions, census information, or the like. As noted, these databases 408 may be accessed before, during, or after advertising campaigns. For example, prior to a campaign, a list of system users may be provided to a credit agency 432 to obtain detailed demographic, purchasing behavior, or interest information for use in targeting advertisements to users of the system. During a campaign, the databases 408 may be accessed to tune targeting or obtain information regarding conversions. After an advertising campaign, the databases 408 may be accessed for conversion information or demographic information to analyze the results of a campaign.

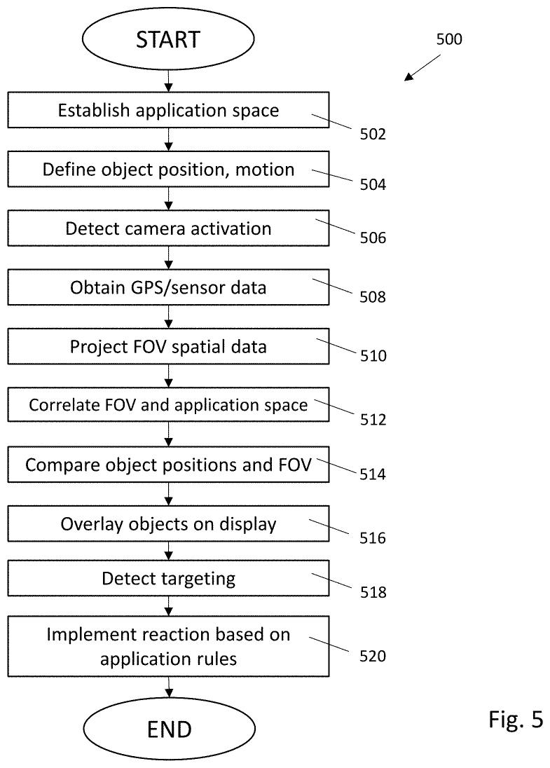

FIG. 5 is a flowchart illustrating a process 500 for operating an augmented reality system in accordance with the present invention. The process 500 is initiated by establishing (502) an application space for the system. For example, the application may service a metropolitan area or a country. A coordinate system can then be established to define the position and movement of application objects. For example, the coordinate system may be based on geo codes or another defined coordinate system. Then, the position and motion of individual application objects can be defined (504). For example, in the case of an advertising campaign, an advertising object may include a name or logo of a vendor together with a coupon, advertising message, or other advertising content. The campaign parameters may define specific geographic zones where the application object is to be presented to users. Moreover, movement of the application object (translation of position as well as any rotation of the object) may be defined by an advertiser or other system user or by a system administrator. In any case, the geographic zones where application objects are to be presented as well as parameters of motion can be defined in relation to the application space.

As noted above, the application objects may be overlaid on a digital image, for example, a real-world video image presented on a user interface screen, headset, glasses, or the like. Accordingly, an application of the augmented reality system may monitor camera operation to detect (506) camera activation. In this regard, the application may continuously monitor camera operation or may monitor camera activation after the application has been explicitly launched. In any case, upon detecting camera activation, the application may obtain (508) position information and sensor data for the user device. For example, the position information may be GPS information or position information obtained from another source, e.g., via triangulation within a mobile network. The sensor data may include data from tilt sensors, accelerometers, or other sensors provided by the user device. The application may also obtain information regarding a field of view of the camera of the user device. For example, the default field-of-view parameters may be utilized or specific field-of-view parameters associated with an optical or digital zoom function or the like may be obtained.

Based on this information, the application can project (510) field-of-view spatial data. For example, if the application knows the geo coordinates of the camera, the orientation of the camera aperture, and the field-of-view of the camera, the application can project the spatial extent (e.g., a conical imaging region or rectangular displayed subset thereof) of the field-of-view. This field-of-view can then be correlated (512) to the application space. In the case where the application space is defined relative to standardized geo coordinates and the field-of-view is also defined in relation to standardized geo coordinates, this process is straightforward. In other cases, well-known mathematical translations can be utilized in this regard.

The application can then compare (514) object positions and the field-of-view. Thus, any advertising object having a current position that is within the spatial extent of the field-of-view can be overlaid (516) on the digital presentation of the field-of-view at an appropriate location (i.e., corresponding to the current position of the application object in the field-of-view as displayed). Moreover, the appearance of the application object in the display may be controlled to convey the illusion that the virtual application object is present in the digital display of the field-of-view, i.e., such that the size and orientation of the object reflects proximity or distance within the field-of-view and an orientation of the application object changes depending on the point of view of the camera.

As noted above, the user can move the user device to target a desired application object. To assist in targeting, a reticle may be overlaid on the display. The user can then move and tilt the user device until the reticle is aligned with a desired application object. Selection of the application object may be accomplished simply by aligning the object in relation to reticle or a further action such as a tap on the screen may be employed to select the application object. In any case, the application may detect (518) such targeting. As noted above, upon detecting targeting, the application may cause the application object to become enlarged, change in color, become outlined, or otherwise be highlighted to provide an indication to the user that the application object has been targeted. In addition, tactile feedback and/or sounds may be utilized to indicate targeting. The application can then implement (520) a reaction based on application rules. For example, in the case of an advertising system, selection of the application object may result in crediting an account of the user or providing a coupon to the user. In the case of a game, targeting of the application object may result in game credits or acquisition of abilities or skills. It will be appreciated that many other reactions are possible depending on the nature of the application.

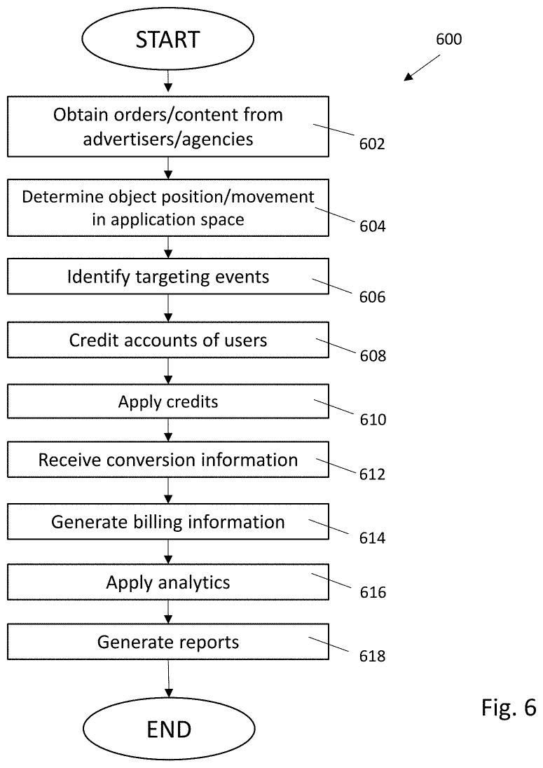

FIG. 6 illustrates a process 600 for operating an augmented reality system in accordance with the present invention in the context of an advertising campaign. The illustrated process 600 is initiated by obtaining (602) orders and advertising content from an advertiser or advertising agency. As noted above, the orders may define geographic zones where application objects are to be presented as well as demographics or other targeting parameters of a targeted audience segment. The advertising order may specify a desired motion of the application object or such motion may be specified by a system operator. In any case, the position and movement of the application object can then be determined (604) in relation to the defined application space. The motion may be defined by velocity, acceleration, angular velocity and angular acceleration of the object. Thus, the position and orientation of the application object can be determined for any defined moment in time.

As discussed above, the user can then manipulate the user device to target virtual application objects overlaid on the display of a digital image such as from a digital camera of the user device. As this is occurring, the augmented reality system can identify (606) targeting events. A targeting event may occur when the camera is aligned with an application object and/or when the user provides an input to indicate selection of an application object. In the case of an advertising application, upon occurrence of a targeting event, an account of the user may be credited (608) for the targeting event. For example, such a credit may involve activating a coupon, activating a discount offer for products or services, or otherwise providing value to the user in connection with targeting of the advertising object. Subsequently, such credits may be applied (610) for the benefit of the user. For example, upon making a purchase related to the application object, a discount or credit may be applied towards the purchase. Alternatively, credits may be aggregated and applied towards a billing statement of the user, e.g., in connection with network services, credit card statements, or the like.

The augmented reality system may also receive (612) conversion information. Such conversion information may relate to visiting a website associated with the advertiser, purchasing a product or service associated with the application object, or otherwise taking an action desired by the advertiser. Such conversion information may be obtained from credit agencies, loyalty program databases, or other sources and may be provided via a data network or other means. The conversion information may be used, for example, to generate (614) billing information for advertisers, to apply (616) analytics for analyzing the effectiveness of an advertising campaign, or for other analysis. In the case of billing or campaign analysis, reports may be generated (618) and provided to advertisers or other interested parties.

It will be appreciated that the invention is applicable to a variety of other use cases and applications. For example, the AR system may be used to implement an AR gaming application. In such a case, gaming application objects may be discovered, targeted, and captured or otherwise interacted with to accumulate game credits. Those skilled in the art will readily understand that the AR system could be applied with respect to educational, training, and many other types of applications.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A method for allowing user devices to interact with a virtual application space, comprising:
establishing an application space including a virtual spatial environment defined by spatial axes;
rendering at least a first application object in said application space;
providing a user device having device sensors indicating a real-world position and orientation of said user device;
obtaining sensor information from said device sensors;
using said sensor information to establish a dynamically variable field of view for a display of said user device relative to said virtual application space; and
monitoring said field of view to identify a targeting of a first object of said application objects within said field of view so as to enable and interaction of a user with said application object.

2. The method of claim 1, wherein said virtual application environment of said application space is defined in relation to three spatial axes.

3. The method of claim 1, wherein said rendering comprises depicting said application object as an image element on said display of said user device at a display location correlated to a position in said application space.

4. The method of claim 1, wherein said rendering comprises defining a time-dependent position of said application object relative to said application space.

5. The method of claim 4, wherein said application object has a defined velocity at a defined time in relation to said application space.

6. The method of claim 4, wherein said application object has a defined acceleration at a defined time in relation to said application space.

7. The method of claim 1, wherein said user device is a mobile device.

8. The method of claim 7, wherein said mobile device is one of a phone and a tablet computer.

9. The method of claim 1, wherein said user device includes a camera and a processor, wherein said camera is operative for providing real-time digital images of a real world environment on said display, and said processor is operative to overlay said application objects of said application space on said real time digital images of said real world environment.

10. The method of claim 9, wherein said field of view corresponds to a camera field of view of said camera.

11. The method of claim 9, wherein said field of view is defined in relation to said application space using said sensor information.

12. The method of claim 1, wherein said monitoring comprises rendering a targeting aid relative to said application space on said display.

13. The method of claim 12, wherein said targeting aid comprises a reticle.

14. The method of claim 12, wherein said monitoring comprises altering a display of said application object responsive to detecting a position of said application object in relation to said targeting aid.

15. The method of claim 14, wherein said altering comprises changing one of a size and a color of said application object.

16. The method of claim 1, wherein said monitoring comprises detecting a user input entered in relation to said targeting of said application object.

17. The method of claim 16, further comprising crediting an application value in response to said user input entered in relation to said targeting of said application object.

18. The method of claim 17, wherein said application space is a game space of a game and said crediting comprises crediting a game value to said user.

19. The method of claim 17, wherein said application space relates to an application for promoting third-party products or services.

20. The method of claim 19, wherein said application value is redeemable in relation to a transaction involving said third party products or services.

21. The method of claim 19, further comprising operating said user device to report said application value to a network platform.

22. A promotional system, comprising:
a user device for:
generating application objects related to third-party products or services;
associating individual ones of said application objects with application values;
superimposing an application space including said application objects on a digital image space;
obtaining user targeting interaction information to identify targeting of a first application object of said application objects and rendering a targeting effect relating to said targeting of said first application object in said application space;
obtaining user selection information related to selection of said first application object by a user;
crediting a first application value of said application values corresponding to said first object in response to said selection; and
reporting said application value to a network platform.

23. A promotional system for use in connection with a user device for displaying virtual application objects related to third-party products or services in relation to a digital image space and allowing users to make a selection in relation to the virtual application objects, said promotional system comprising:
a network platform for:
receiving application information from said user device related to selection of a first virtual application object by a first user;
accessing storage two credit a first value to a first account of said first user in relation to said selection of said first virtual application object, said first value being redeemable in connection with a first transaction between said first user and a first provider of goods or services; and
providing account information concerning said first account of said first user to said first provider.

24. A promotional system for use in connection with an application device running an application for generating virtual application objects related to third-party products or services in relation to an application space, said promotional system comprising:
an imaging device for:
rendering a real-world digital image in a display;
receiving application information from said application including a first virtual application object having a defined location in relation to said application space, wherein said application space has a defined correlation to a real-world space of said real-world digital image; and
superimposing said first virtual application object on said real-world digital image of said display.
